(19) United States
(12) Patent Application Publication
(10) Pub. No.: US 2015/0107114 A1
(43) Pub. Date: Apr. 23, 2015

(54) SHAVING AID MEMBER ASSEMBLIES FOR RAZORS

(71) Applicants: Lee Minsk, Caldwell, NJ (US); Joshua Bennett, Ridgefield, CT (US)

(72) Inventors: Lee Minsk, Caldwell, NJ (US); Joshua Bennett, Ridgefield, CT (US)

(21) Appl. No.: 14/058,369

(22) Filed: Oct. 21, 2013

(51) Int. Cl. B26B 21/44

(52) U.S. Cl. CPC B26B 21/44
USPC 30/41

(57) ABSTRACT

A shaving aid member assembly for adding a shaving aid member to a razor that does not have a shaving aid member or for replacing a worn out shaving aid member. The shaving aid member assembly comprising a horizontal band portion made of elastic material and a shaving aid member disposed on an outer facing surface of the horizontal band portion, wherein the horizontal band portion comprises a continuous loop for removably fastening the horizontal band portion around the perimeter of the razor's shaving head. The shaving aid member assembly may further comprise first and second vertical band portions extending perpendicularly from the horizontal band portion and each comprising a continuous loop for removably fastening the first and second vertical band portions around the vertical perimeter of the shaving head.

### FIELD OF THE INVENTION

The present invention relates to the field of shaving implements, and more particularly, to shaving aid member assemblies for razors capable of adding or replacing shaving aid members.

### BACKGROUND OF THE INVENTION

Safety razors generally include a shaving head with blades attached to a handle. The shaving head, sometimes referred to as a cartridge, may be disposable in which case the shaving head is releasably attached to the handle and may be discarded once its blades are dull. In other safety razors, called disposable razors, the shaving head is fixed to the handle, in which case the entire razor is discarded after it is worn out. Safety razors typically utilize one or more shaving aid members, such as lubricating gel strips, for providing lubrication and moisture while shaving and allowing the blades to glide on the skin. Shaving aid members are normally mounted on the shaving head of the razor, in front of the blades. They are made of materials that absorb water and become slippery, thus creating a lubricating surface that helps the blades to glide across the surface of the skin. Shaving aid members make the shave more comfortable by easing any discomfort felt on the skin while shaving and decreasing the risk of snagging, cutting or irritation of the skin. Ultimately, however, the shaving aid member wears away, leaving the skin exposed to cuts and irritation. Typically, after the shaving aid member wears away, the user disposes of the disposable cartridge or of the entire razor. Often, however, the shaving aid member wears out before the actual razor becomes dull. As such, current safety razors are not efficient or economic.

Various solutions have been introduced to solve the aforementioned problem. One such solution is in the form of a roll of a plurality of flexible elongated strips of shaving aid material with an adhesive backing. While the adhesive strip has the benefit of adding a shaving aid member to a shaving head that did not previously contain a shaving aid member, it would be difficult to use the adhesive strip to replace a worn out shaving aid member. The adhesive strip cannot be effectively affixed to a worn out shaving aid member because the worn out shaving aid member will continue to absorb some water causing the adhesive ineffective. Other solutions provide a shaving aid member on a holder that is attached to the shaving head using sliding mechanisms, grooves in the shaving head, or clips on the shaving aid holder and recesses on the shaving head. However, such shaving aid holders may only be received by proprietary shaving heads specifically sized and designed to receive such shaving aid holders. These shaving aid holders cannot be mounted on conventional shaving heads.

There is therefore a need for shaving aid member assemblies capable of adding shaving aid members to razors that do not have shaving aid members or replacing worn out shaving aid members. In addition, there is a need for universal shaving aid member assemblies for razors capable of adding or replacing shaving aid members of any razor size and design.

### SUMMARY OF THE INVENTION

An object of the invention is to overcome the drawbacks of previous inventions.

Another object of the invention is to provide novel and useful shaving aid member assemblies capable of adding shaving aid members to razors that do not have shaving aid members.

Another object of the invention is to provide novel and useful shaving aid member assemblies for razors capable of replacing worn out shaving aid members.

Another object of the invention is to provide universal shaving aid member assemblies for razors capable of adding or replacing shaving aid members of any razor size and design.

In a preferred embodiment, the shaving aid assembly includes a horizontal band portion made of elastic material and a shaving aid member disposed on an outer facing surface of the horizontal band portion, wherein the horizontal band portion comprises a continuous loop for removably fastening the horizontal band portion around the perimeter of the shaving head. In another embodiment, the shaving aid member assembly may further comprise first and second vertical band portions extending perpendicularly from the horizontal band portion and each comprising a continuous loop for removably fastening the first and second vertical band portions around the vertical perimeter of the shaving head.

### BRIEF DESCRIPTION OF THE DRAWINGS

A further understanding of the invention can be obtained by reference to a preferred embodiment set forth in the illustrations of the accompanying drawings. Although the illustrated embodiment is merely exemplary of systems and methods for carrying out the invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the invention, reference is now made to the following drawings in which:

FIG. 1A is a perspective front view of a shaving aid member assembly and a shaving razor according to a preferred embodiment of the invention;

FIG. 1B is a perspective front view of the shaving aid member assembly of FIG. 1A fastened to the shaving razor;

FIG. 1C is a perspective rear view of the shaving aid member assembly of FIG. 1A fastened to the shaving razor;

FIGS. 2A-2D are cross-sectional views along line 2-2 in FIG. 1A of various preferred embodiments of the construction of shaving aid member assembly;

FIG. 3A is a perspective front view of a shaving aid member assembly and a shaving razor according to an alternative embodiment of the invention;

FIG. 3B is a perspective front view of the shaving aid member assembly of FIG. 3A fastened to the shaving razor;

FIG. 3C is a perspective rear view of the shaving aid member assembly of FIG. 3A fastened to the shaving razor;

FIG. 4 is a front view of a shaving aid member according to an alternative embodiment of the invention;

FIG. 5A is a perspective front view of shaving aid member assembly and a shaving razor according to another alternative embodiment of the invention;

FIG. 5B is a perspective front view of the shaving aid member assembly of FIG. 5A fastened to the shaving razor;

FIG. 5C is a perspective rear view of the shaving aid member assembly of FIG. 5A fastened to the shaving razor;

FIG. 5D is a perspective front view of the shaving aid member assembly of FIG. 5A;

FIG. 6 is a perspective front view of a shaving aid member assembly according to another embodiment of the present invention;

FIG. 7A is a perspective front view of shaving aid member assembly and a shaving razor according to another alternative embodiment of the invention;

FIG. 7B is a perspective front view of the shaving aid member assembly of FIG. 7A fastened to the shaving razor; and

FIG. 7C is a perspective rear view of the shaving aid member assembly of FIG. 7A fastened to the shaving razor.

### DETAILED DESCRIPTION OF THE INVENTION

The invention may be understood more readily by reference to the following detailed description of preferred embodiment of the invention. However, techniques, systems and operating structures in accordance with the invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the invention. It must be noted that, as used in the specification and the appended claims, the singular forms “a”, “an”, and “the” include plural referents unless the context clearly indicates otherwise.

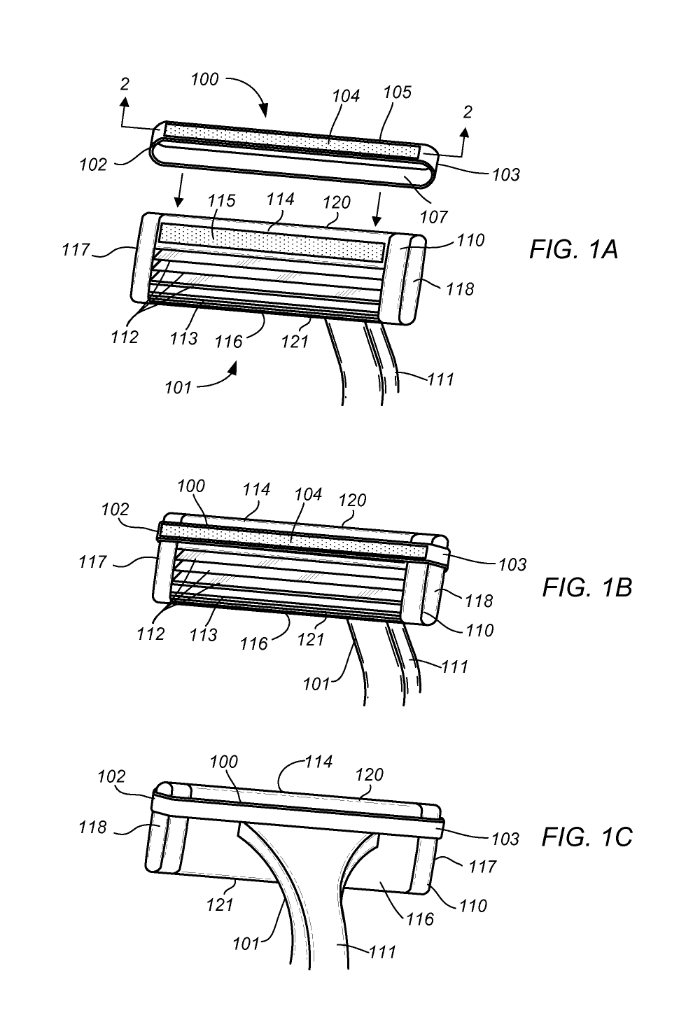

Referring now to FIGS. 1A-1C, there is shown a perspective front view of a shaving aid member assembly 100 to be used with a shaving razor 101, which is made in accordance with the teachings of the preferred embodiment of the invention. Shaving razor 101 may be any conventional razor known in the art or which may be later discovered. As shown, shaving razor 101 may comprise a shaving head 110 attached to a handle 111. Shaving head 110 may be fixedly attached to handle 111. In such a case, when the blades 112 become dull after shaving, the entire razor 101 may be disposed. Alternatively, shaving head 110, sometimes referred to as a cartridge, may be disposable. As such, it may be removably attached to handle 111 via connecting members, such as clips (not shown), as is well known in the art. When blades 112 become dull, the cartridge is disposed and is replaced with a new cartridge.

Shaving head 110 extends from a first side wall 117 to a second side wall 118 and includes oppositely disposed front and rear faces 114 and 116 extending between the first and second side walls 117 and 118. Shaving head 110 further includes top and bottom walls 120 and 121. Shaving head 110 may comprise three blades 112 disposed on its front face 114 between the first and second side walls 117 and 118. Alternatively, shaving head 110 may include one, two, four, or other number of blades as is known in the art. Shaving head 110 may or may not include a guard portion 113 disposed on its front face 114 below the blades 112 near bottom wall 121. Guard portion 113 includes a plurality of horizontal grooves for prestretching the skin and aligning the shaving head 110 with the skin prior to shaving. In addition, shaving head 110 may or may not include a shaving aid member 115 on its front face 114 above the blades 112 near top wall 120 for providing lubrication and moisture while shaving and allowing the blades 112 to glide on the skin.

The shaving aid member assembly 100 of the present invention generally comprises an elongated body 102 having a horizontal band portion 103 and a shaving aid member 104 disposed on the outer facing surface 105 of the horizontal band portion 103. Shaving aid member assembly 100 of the present invention allows the shaving aid member 104 to be added to shaving razors with or without an existing shaving aid member, such as shaving aid member 115. For those razors without shaving aid members, the shaving aid member assembly 100 of the present invention will allow for a shaving experience provided by razors with existing shaving aid members. For those razors with a shaving aid member 115, as shown in FIG. 1A, the shaving aid member assembly 100 of the present invention will allow the razor 101 to keep working even after the included shaving aid member 115 becomes exhausted, but before blades 112 become dull. As such, the shaving aid member assembly 100 of the present invention provides a better, efficient, and economic shaving experience. When the shaving aid member 104 becomes exhausted, the shaving aid member assembly 100 is removed from shaving head 110 and is simply discarded and replaced with another shaving aid member assembly. Because of its design, the shaving aid member assembly 100 does not need to be affixed to a proprietary shaving head—it may be affixed to any conventional shaving razor known in the art, irrespective of its design.

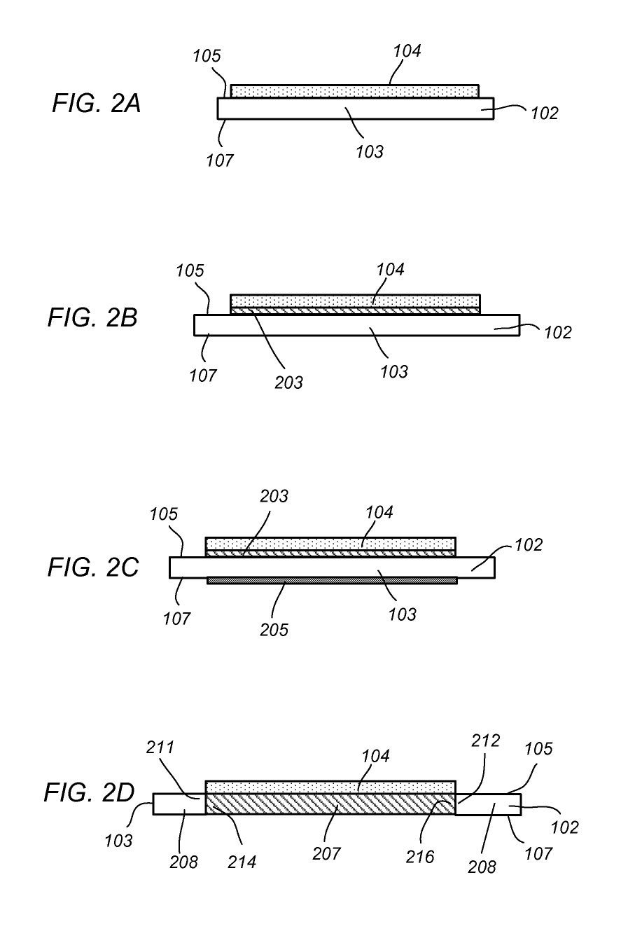

Horizontal band portion 103 of the shaving aid member assembly 100 is preferably in a form of a continuous loop. In a preferred embodiment, horizontal band portion 103 comprises elastic waterproof material having desired elastic properties such that it can be stretched to removably fasten the shaving aid member assembly 100 horizontally around the shaving head 110 as shown in FIGS. 1B and 1C. Particularly, horizontal band portion 103 is removably fastened around the perimeter of the shaving head 110 with its inner surface 107 over the front face 114, around the first side wall 117, over the rear face 116, and around the second side wall 118 of the shaving head 110. As such, horizontal band portion 103 preferably comprises a perimeter or circumference in an unstretched state that is less than the horizontal perimeter of a conventional shaving head 110. The elastic properties of the shaving aid member assembly 100 ensure that the shaving aid member assembly 100 remains affixed to the shaving head 110 during shaving. The horizontal band portion 103 may comprise any desired shape in an unstretched state, including an oval, an ellipse, a circle, a rectangle, a rectangle with rounded sides as show in FIG. 1A, or any other shape. The entire horizontal band portion 103 may comprise elastic material, or only a portion of the horizontal band portion 103 may comprise elastic material as will be later described with reference to FIG. 2D. Elastic material may comprise natural rubber, synthetic rubber, elastomer, silicone, silicone-rubber, latex, rubber-like materials, or any other elastic material known in the art or which may be later discovered.

In a preferred embodiment, shaving aid member assembly 100 is affixed to the shaving head 110 right above the blades 112 and below top wall 120 as shown in FIGS. 1B-1C. In an alternative embodiment, shaving aid member assembly 100 may be affixed below blades 112 and above bottom wall 121. In addition, two shaving aid member assemblies 100 may be used, one affixed above blades 112 and another affixed below blades 112. Such shaving aid member assemblies 100 may comprise shaving aid members 104 having the same material, or two different materials for providing different benefits to the shaving experience.

Shaving aid member assembly 100 comprises shaving aid member 104 disposed on the outer surface 105 of the horizontal band portion 103. Shaving aid member 104 is preferably in the form of a strip comprising a length slightly smaller than the width of a conventional shaving head 110. Alternatively, shaving aid member 104 may extent over the entire perimeter of outer surface 105 of horizontal band portion 103. Shaving aid member 104 preferably comprises shaving aid material or composition for enhancing the shaving performance of the razor 101 and providing desired benefits to the skin. Any shaving aid material known in the art may be utilized to form the shaving aid member 104. In addition, various shaving aid member assemblies 100 may be provided containing shaving aid members 104 made from a variety of materials such that a user can interchange or substitute the shaving aid member assemblies 100 during shaving depending on the desired shaving benefits. Shaving aid member 104 may comprise water release agents; water soluble materials; gels; lubricants; moisturizers; conditioners; extracts, such as aloe vera extract, gel extracts, or the like; soap based compositions; surfactants, such as stearic acid, or the like; vitamins, such as vitamin E, or the like; cooling agents, such as eucalyptus, menthol, or the like; antibacterial agents, such as triclosan, or the like; antioxidants, such as grapefruit seed extract, or the like; stabilizers; colorants; preservatives; or combinations thereof.

Shaving aid member 104 may further comprise wear indicators, such as a plurality of colored layers, to indicate the use of the shaving aid member 104. For example, shaving aid member 104 may comprise a white layer on top of a red layer. As the shaving aid member 104 is used, the red layer will show through, indicating to the user that the shaving aid member 104 is about to be exhausted and must be replaced. Furthermore, shaving aid member 104 may also comprise a guard containing grooves, such as guard 113, for stretching out the skin prior to shaving. As such, shaving aid member assembly 100 may be fastened to a shaving head 110 that does not already have a guard 113 to enhance the shaving experience.

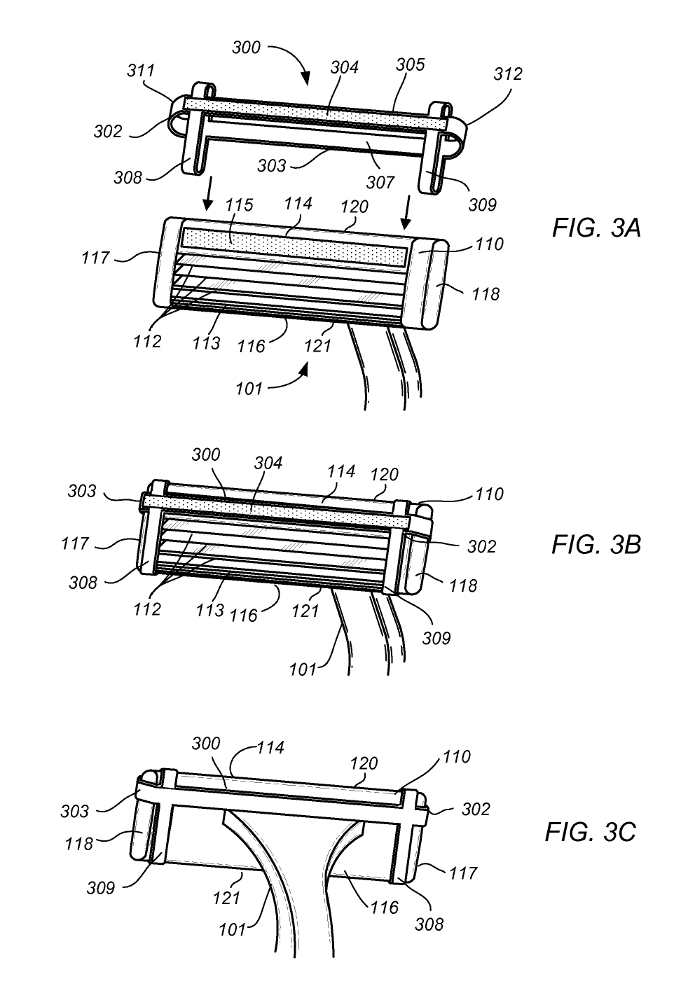

FIGS. 2A-2D illustrate cross-sectional views along line 2-2 shown in FIG. 1A of various preferred embodiments of the construction of shaving aid member assembly 100, as well as of other embodiments of the shaving aid member assemblies illustrated in FIGS. 3A-3C, 5A-5D, 6, and 7A-7C. Referring first to FIG. 2A, elongated body 102 may comprise horizontal band portion 103 or a first layer and shaving aid member 104 or a second layer disposed on the outer surface 105 of the horizontal band portion 103. Horizontal band portion 103 may be formed of a continuous loop of elastic material. In one embodiment, shaving aid member 104 may comprise elastic material and can be stretched out together with the horizontal band portion 103. In an alternative embodiment, as shown in FIG. 2B, elongated body 102 may comprise a middle or third layer of material 203 disposed between the horizontal band portion 103 and the shaving aid member 104. Third layer of material 203 is preferably formed of a non-elastic or rigid material for providing stability to the shaving aid member 104 and for preventing the shaving aid member 104 from stretching out and thereby breaking. Third layer of material 203 may be made of plastic, metal, resin material, or the like. Preferably, third layer of material 203 is substantially the same size or slightly larger than shaving aid member 104. In another embodiment, as shown in FIG. 2C, elongated body 102 may comprise a lower or fourth layer of material 205 disposed on the inner surface 107 of the horizontal band portion 103. Fourth layer of material 205 is provided to come into contact with the front face 114 of the shaving head 110 for preventing elongated body 102 from sliding with respect to the shaving head 110. Accordingly, fourth layer of material 205 may comprise ribbed surface or may be made of friction resistant material, such as silicone. The fourth layer of material 205 may be substantially the same size as the shaving aid member 104, or it may extend along the entire inner surface 107 of horizontal band portion 103. In another alternative embodiment, the horizontal band portion 103 may comprise material with friction resistant properties.

As shown in FIG. 2D, horizontal band portion 103 may comprise an elastic portion 208 and an intermediate portion 207. The elastic portion 208 is made of elastic material and is connected at its first end 211 to the first end 214 of the intermediate portion 207 and at its second end 213 to the second end 216 of the intermediate portion 207. Preferably, shaving aid member 104 is disposed on the intermediate portion 207, which may be made from rigid material, like the third layer of material 203, for preventing the shaving aid member 104 from stretching and breaking. Intermediate portion 207 may be substantially the same size as shaving aid member 104, or it may be slightly larger.

Elongated body 102 may comprise one or more layers described in FIGS. 2A-2D in any desired configuration. In a preferred embodiment, the various layers of the shaving aid member assembly 100 are molded to form a substantially unitary body 102. Alternatively, the various layers may be attached to each other by adhesives, mechanical locking means, by injection molding processes known in the art, by spraying, or by other ways known in the art. For example, the fourth layer of material 205 may be sprayed onto the inner surface 107 of the horizontal band portion 103.

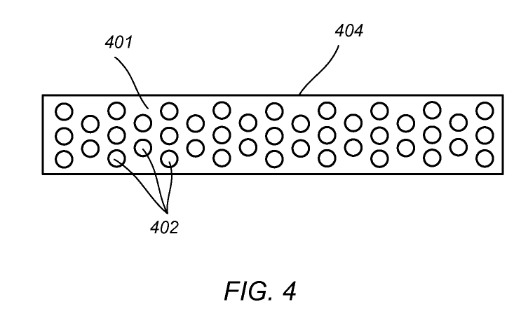

Shaving aid member 104 is preferably provided in the form of a strip, or any other known form. As shown in FIG. 4, shaving aid member 404 may comprise a plurality of shaving aid portions of shaving aid material 402 disposed on backing 401 or directly on horizontal band portion 103 as shown in FIG. 2A. Backing 401 may comprise the same material as third layer of material 203 shown in FIG. 2B. Shaving aid portions 402 may be in the shape of circles, triangles, rectangles, hearts, starts, or any other desired shape.

FIGS. 3A-3C illustrate shaving aid member assembly 300 to be used with a shaving razor 101, according to an alternative embodiment of the invention. Shaving aid member assembly 300 comprises an elongated body 302 comprising a horizontal band portion 303, such as horizontal band portion 103, and first and second vertical band portions 308 and 309. Horizontal band portion 303 is in the form of a continuous loop and is adapted to be removably fastened around the horizontal perimeter of shaving head 110, right above blades 112 and below top wall 120, as shown in FIGS. 3B-3C. Horizontal band portion 303 extends from a first end 311 to a second end 312 and comprises shaving aid member 304, similar to shaving aid member 104, disposed on its outer surface 305. First vertical band portion 308 extends perpendicularly to the horizontal band portion 303 at its first end 311 and second vertical band portion 309 extends perpendicularly to the horizontal band portion 303 at its second end 312. First and second vertical band portions 308 and 309 are formed of continuous loops adapted to be removably fastened around the vertical perimeter of shaving head 110 as shown in FIGS. 3B-3C. Particularly, first and second vertical band portions 308 and 309 extend over front face 114, around top wall 120, over rear face 116, and around bottom wall 121 of shaving head 110. First and second vertical band portion 308 and 309 are preferably spaced apart from one another to accommodate the width of conventional blades 112. First vertical band portion 308 is preferably secured between blades 112 and first side wall 117 and second vertical band portion 309 is preferably secured between blades 112 and second side wall 118. First and second vertical band portions 308 and 309 increase stability to the shaving aid member assembly 300 and ensure that it remains flush with the shaving head 110. Horizontal band portion 303 and first and second vertical band portions 308 and 309 are preferably made of elastic material, such as the materials described above with reference to FIGS. 1A-1C, which allow the shaving aid member assembly 300 to be stretched and fitted over the shaving head 110. Horizontal band portion 303 and first and second vertical band portions 308 and 309 may be molded from a single piece of material. Alternatively, first and second vertical band portions 308 and 309 may be attached to the horizontal band portion 303 by an adhesive, mechanical locking means, molding, or by any other means known in the art.

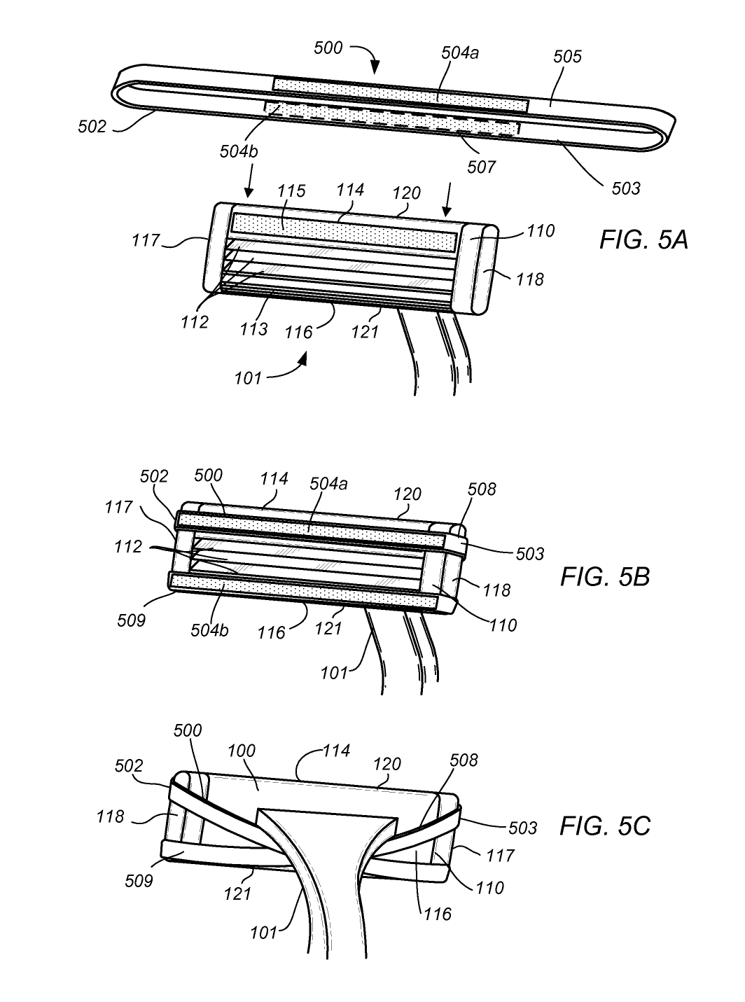

FIGS. 5A-5D illustrate shaving aid member assembly 500 to be used with a shaving razor 101, according to another alternative embodiment of the invention. Shaving aid member assembly 500 comprises an elongated body 502 having a horizontal band portion 503, similar to horizontal band portion 103. Horizontal band portion 503 is in the form of a continuous loop, and preferably comprises length that is slightly less than twice the horizontal perimeter of shaving head 110. Horizontal band portion 503 is adapted to be crisscrossed (as shown in FIG. 5D) such that it comprises a first horizontal portion 508 and a second horizontal portion 509 that meet at a crisscross region 506. First horizontal portion 508 can be removably fastened around the horizontal perimeter of shaving head 110, right above blades 112 and below top wall 120, as shown in FIGS. 5B-5C. Second horizontal portion 509 can be removably fastened around the horizontal perimeter of shaving head 110, right below blades 112 and above bottom wall 121. Particularly, first and second horizontal portions 508 and 509 each extend with its inner surface 507 over the front face 114, around the first side wall 117, over the rear face 116, and around the second side wall 118 of the shaving head 110. First and second horizontal portions 508 and 509 meet at a crisscross region 506 as shown in FIG. 5D, where the elongated body 502 crisscrosses. First and second horizontal portions 508 and 509 comprise shaving aid members 504a and 504b, similar to shaving aid member 104, disposed on the outer surface 505 of the elongated body 502. As such, shaving aid member assembly 500 allows for addition of shaving aid members 504a and 504a above and below the blades 112. Alternatively, shaving aid member assembly 500 may comprise a single shaving aid member 504a or 504b. First and second horizontal portions 508 and 509 further increase stability to the shaving aid member assembly 500 and ensure that it remains flush to the shaving head 110. First and second horizontal portions 508 and 509 are preferably made of elastic material, such as the materials described above with reference to FIGS. 1A-1C, which allow the shaving aid member assembly 500 to be stretched and fitted over the shaving head 110.

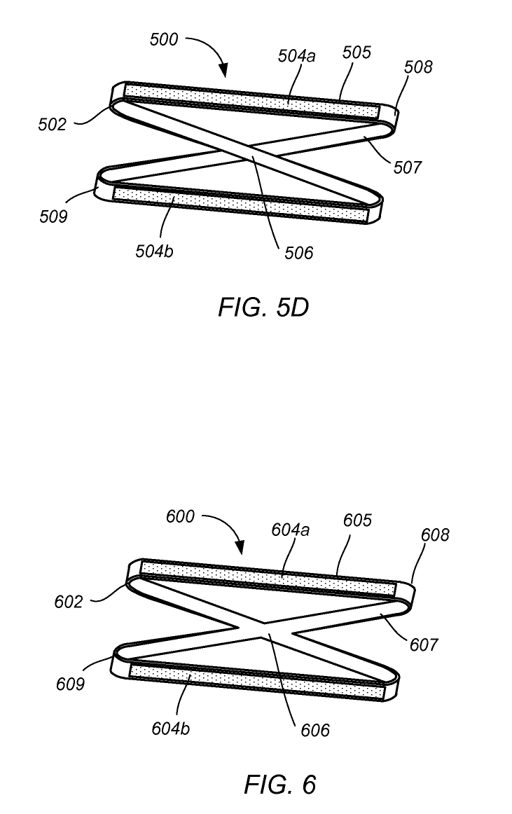

In an alternative embodiment, as shown in FIG. 6, shaving aid member assembly 600 may comprise an elongated body 602 having first and second horizontal portions 608 and 609 (similar to first and second horizontal portions 508 and 509 of FIGS. 5A-5D) connected with a connection portion 606. As such, the shaving aid member assembly 600 does not need to be crisscrossed before use. Connection portion 606 preferably comprises an X shape. However, connection portion 606 may comprise any other shape, such as a rectangle, a square, a circle, a heart, a star, and the like. Shaving aid member assembly 600 is affixed to the shaving head 110 in a similar configuration as shaving aid member assembly 500 shown in FIGS. 5B-5C, with its inner surface 607 resting against the shaving head 110. First and second horizontal portions 608 and 609 comprise shaving aid members 604a and 604b, similar to shaving aid member 104, disposed on the outer surface 605 of the elongated body 602. First and second horizontal portions 608 and 609 and the X-shaped connection portion 606 may be molded from a single piece of material. Alternatively, first and second horizontal portions 608 and 609 and the X-shaped connection portion 606 may be attached by an adhesive, mechanical locking means, molding, or by any other means known in the art.

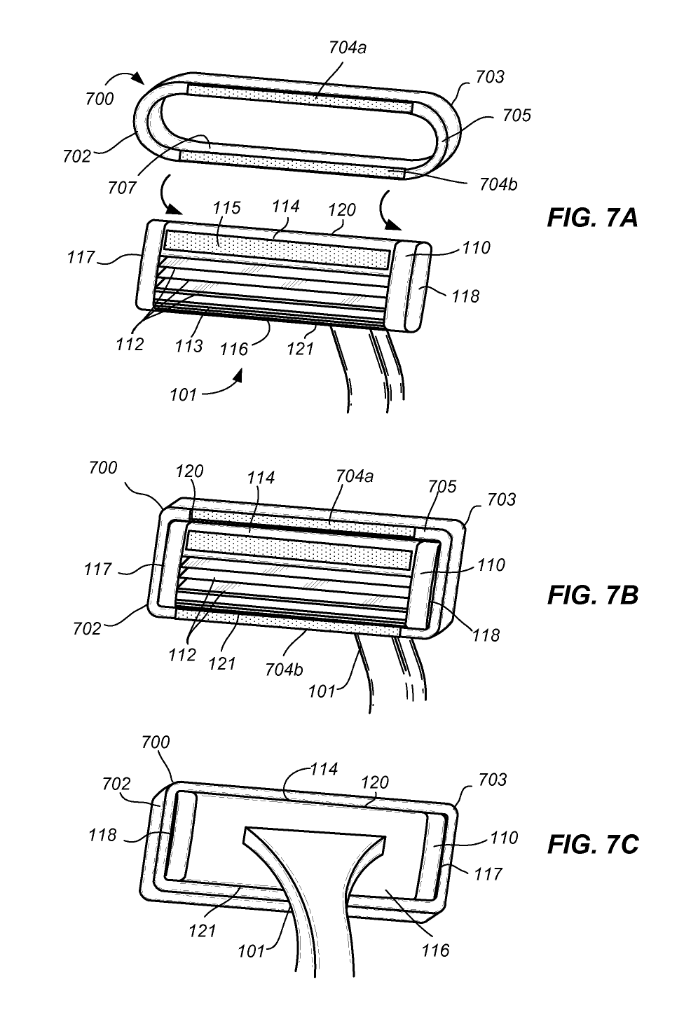

Yet another embodiment of the shaving aid assembly of the present invention is illustrated with reference to FIGS. 7A-7C. Shaving aid member assembly 700 comprises an elongated body 702 having a horizontal band portion 703, similar to horizontal band portion 103. Horizontal band portion 703 is in the form of a continuous loop, and preferably comprises length that is slightly less than the horizontal perimeter of shaving head 110. Horizontal band portion 703 is adapted to be removably fastened around the perimeter of shaving head 110, around the shaving head's 110 outer walls, as shown in FIGS. 7B-7C. Particularly, horizontal band portion 703 extends with its inner surface 707 over the top wall 120, over the first side wall 117, over the bottom wall 121, and over the second side wall 118 of the shaving head 110. Horizontal band portion 703 comprises a first shaving aid member 704a and a second shaving aid member 704b, similar to shaving aid member 104, disposed on its outer side surface 705. In another embodiment, horizontal band portion 703 may comprise a single strip of shaving aid member 704a or 704b. In yet another embodiment, horizontal band portion 703 may comprise a shaving aid member disposed on the entire outer side surface 705 of the horizontal band portion 703. As is apparent in FIGS. 7B and 7C, the design of the shaving aid member assembly 700 allows the shaving aid members 704a and 704b to be flush with the front face 114 of the shaving head 110. Horizontal band portion 703 is preferably made of elastic material, such as the materials described above with reference to FIGS. 1A-1C, which allow the shaving aid member assembly 700 to be stretched and fitted over the shaving head 110.

It should be understood that this invention is not limited to the disclosed features and other similar method and system may be utilized without departing from the spirit and the scope of the invention.

While the invention has been described with reference to the preferred embodiment and alternative embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the invention is capable of being embodied in other forms without departing from its essential characteristics.

1. A shaving aid member assembly for adding a shaving aid member to a razor having a shaving head connected to a handle, said shaving aid member assembly comprising:
a horizontal band portion comprising a continuous loop for removably fastening said horizontal band portion around a perimeter of the shaving head; and
a shaving aid member disposed on an outer surface of the horizontal band portion.

2. The shaving aid member assembly of claim 1, wherein the horizontal band portion comprises elastic material.

3. The shaving aid member assembly of claim 2, wherein the elastic material is selected from the group consisting of natural rubber, synthetic rubber, elastomer, silicone, silicone-rubber, latex, rubber-like material, and a combination thereof.

4. The shaving aid member assembly of claim 1, wherein the horizontal band portion is affixed above or below one or more blades of the shaving head.

5. The shaving aid member assembly of claim 1, wherein the shaving aid member comprises a strip of shaving aid material.

6. The shaving aid member assembly of claim 5, wherein the shaving aid material is selected from the group consisting of a water release agent, a water soluble material, a gel, a lubricant, a moisturizer, a conditioner, an extract, a soap, a surfactant, a vitamin, a cooling agent, an antibacterial agent, an antioxidant, a stabilizer, a colorant, a preservative, and a combinations thereof.

7. The shaving aid member assembly of claim 1, wherein the shaving aid member comprises a wear indicator for indicating that the shaving aid member is about to be exhausted.

8. The shaving aid member assembly of claim 1, wherein the shaving aid member comprises a guard having grooves.

9. The shaving aid member assembly of claim 2, wherein the shaving aid member comprises an elastic material for allowing the shaving aid member to be stretched together with the horizontal band portion.

10. The shaving aid member assembly of claim 1 further comprising a middle layer of material disposed between the horizontal band portion and the shaving aid member, wherein the middle layer of material comprises non-elastic material for preventing the shaving aid member from stretching out.

11. The shaving aid member assembly of claim 10, wherein the middle layer of material is selected from the group consisting of plastic, metal, resin material, and a combination thereof.

12. The shaving aid member assembly of claim 1, further comprising a lower layer of material disposed on an inner surface of the horizontal band portion.

13. The shaving aid member assembly of claim 12, wherein said lower layer of material comprises friction resistant material for preventing said shaving aid member assembly from sliding with respect to the shaving head.

14. The shaving aid member assembly of claim 1, wherein the horizontal band portion comprises an elastic portion connected to an intermediate portion made of rigid material, wherein said shaving aid member is disposed on said intermediate portion.

15. The shaving aid member assembly of claim 1, wherein the shaving aid member comprises a plurality of shaving aid portions of shaving aid material.

16. The shaving aid member assembly of claim 1 further comprising first and second vertical band portions extending perpendicularly from said horizontal band portion, wherein the first and second vertical band portions each comprises a continuous loop for removably fastening said first and second vertical band portions around a vertical perimeter of the shaving head.

17. The shaving aid member assembly of claim 1, further comprising a second horizontal band portion having a continuous loop for removably fastening said second horizontal band portion around the perimeter of the shaving head.

18. The shaving aid member assembly of claim 17, wherein the horizontal band portion is connected to the second horizontal band portion via a connection portion.

19. The shaving aid member assembly of claim 18, wherein the connection portion comprises a shape selected from the group consisting of an X-shape, a rectangle, a square, a circle, a heart, and a star.

20. A shaving aid member assembly for adding a shaving aid member to a razor having a shaving head connected to a handle, said shaving aid member assembly comprising:
a horizontal band portion comprising a continuous loop for removably fastening said horizontal band portion around a horizontal perimeter of the shaving head;
first and second vertical band portions extending perpendicularly from said horizontal band portion, wherein the first and second vertical band portions each comprises a continuous loop for removably fastening said first and second vertical band portions around a vertical perimeter of the shaving head; and
a shaving aid member disposed on an outer facing surface of the horizontal band portion.
